(19) United States
(12) Patent Application Publication
(10) Pub. No.: US 2006/0265812 A1
(43) Pub. Date: Nov. 30, 2006

(54) Sharp mate

(76) Inventors: David Balliette, Clintonville, WI (US); Betty J. Beier, Clintonville, WI (US)

Correspondence Address: DAVID BALLIETTE;BJ BEIER, 86 Sixteenth St, Clintonville, WI, 54929, US

(21) Appl. No.: 11/037,892

(22) Filed: May 25, 2005

(51) Int. Cl. B25F 1/00

(52) U.S. Cl. 7/164

(57) ABSTRACT

A custom molded plastic shell cover made exclusively to fit over each individual tape measure separately manufactured or to be manufactured in the future. two separate pencil sharpeners are molded conveniently on the shell casing. One sharpener is designed to manually sharpen the standard number two pencil while the other is made to manually sharpen the flat carpenter's style pencil. The other options molded right in the shell are a multi-point drill bit gauge and a one inch guide. Separate from the plastic mold is a machined custom fit magnet that slides under the tape measurer after the tape measurer is installed through the bottom opening in the molded shell cover to secure a tight fit and other magnetic conveniences.

Conceived by David J Balliette the “Sharp Mate” is a molded plastic shell that fits over the top of any 25 or 30 foot version tape measure. “Sharp Mate” is custom molded to incase a tight fit to which ever tape measure it's designed for.

Included on the top of the molded shell is a manually operated pencil sharpener designed for the flat carpenter's style pencil. Users must insert the pencil and pull out repeatedly back and forth until pencil is sharpened.

On the left side of the molded shell is a manually operated pencil sharpener designed for the standard number two pencil. Users must insert the pencil and turn it a few times to sharpen it.

Located on the front of the molded shell offset to the right are various size holes designed as a drill bit gauge.

Located on the front of the molded shell offset to the left is a molded imprint of a one inch guide.

Located on the bottom molded shell is the open end for the tape measure installation. Once the tape measure is installed into the molded shell a separate steel magnet machined to fit the length of the bottom is manually slid between the tape measure and a small track molded on each side of the opening as shown.

### FIGURES

FIG. 1 is a front elevational view of the transparent plastic tape measure cover with molded pencil sharpeners, drill bit guage, one inch guide and access hole for tape measure logo.

FIG. 2 is a back elevational view of the transparent plastic tape measure cover with molded pencil sharpeners and access hole for tape measure belt clip.

FIG. 3 is a left side elevational view of the transparent plastic tape measure cover with exposed pencil sharpener and insert hole.

FIG. 4 is a right side elevational view of the transparent plastic tape measure cover with pencil sharpener insert and access hole for tape measure lock.

FIG. 5 is a top plan view of the transparent plastic tape measure cover with pencil sharpener insert holes.

FIG. 6 is a bottom plan view of the transparent plastic tape measure cover with sharpener exit hole exposed.

FIG. 7 is a front elevational view of the custom machined magnet that slides under the tape measure to ensure a secure fit.

FIG. 8 is a back elevational view of the magnet.

FIG. 9 is a left side elevational view of the magnet.

FIG. 10 is a right side elevational view of the magnet.

FIG. 11 is a top plan view of the magnet.

FIG. 12 is a bottom plan view of the magnet.

FIG. 13 is a back side view of the transparent plastic tape measure cover with the manual function of the flat carpenter's pencil and the standard number two pencil including the installation of the magnet.

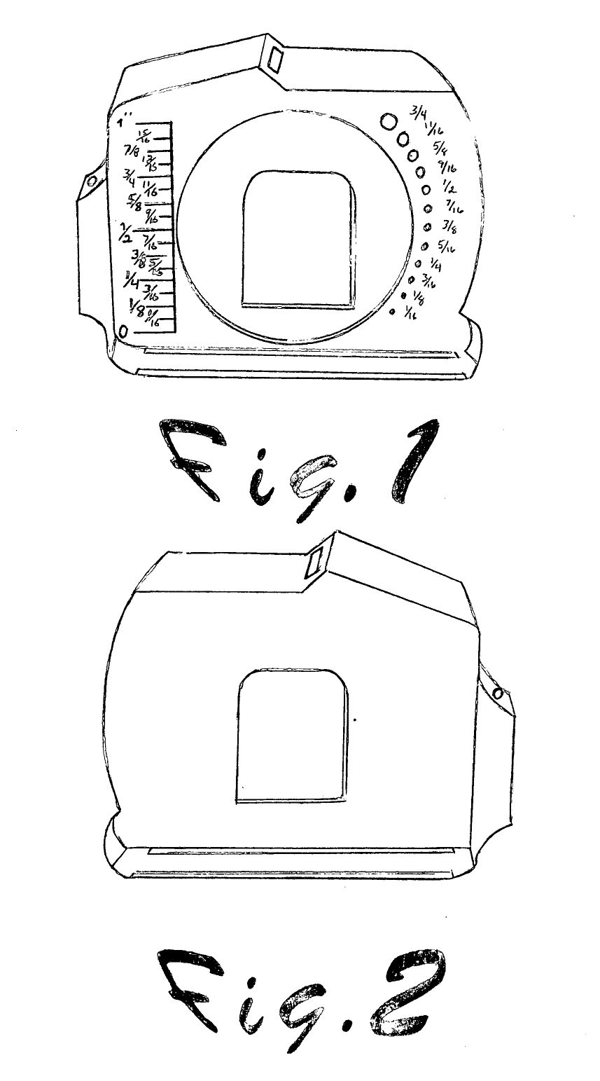

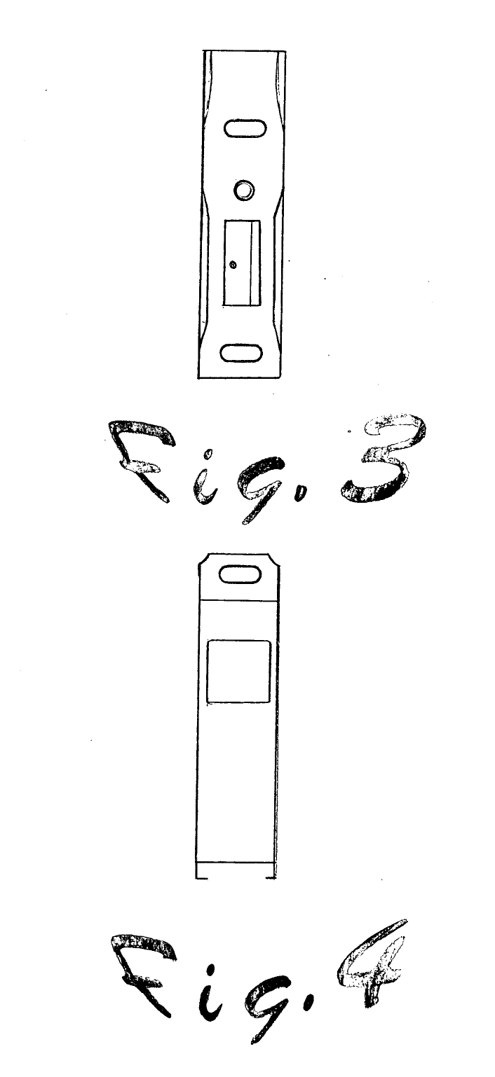

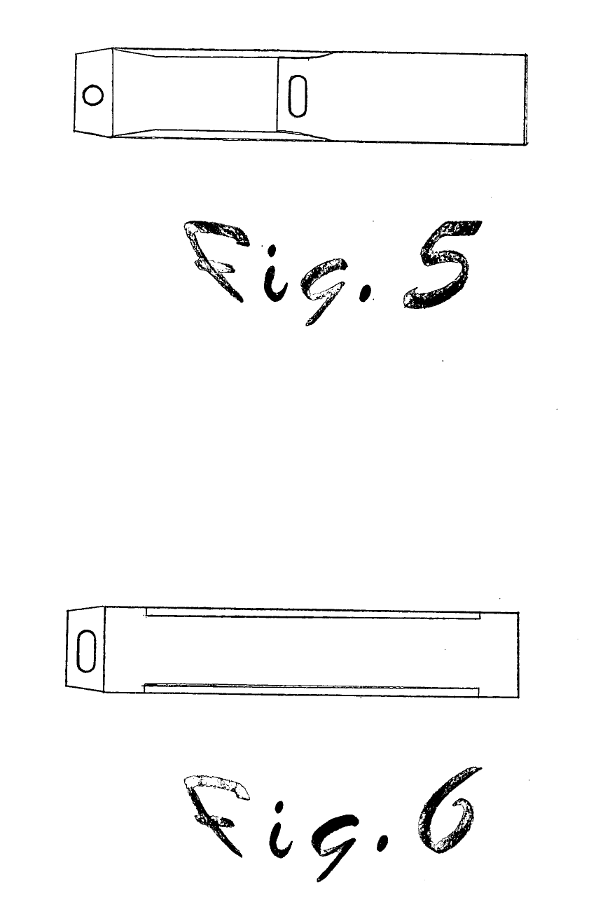

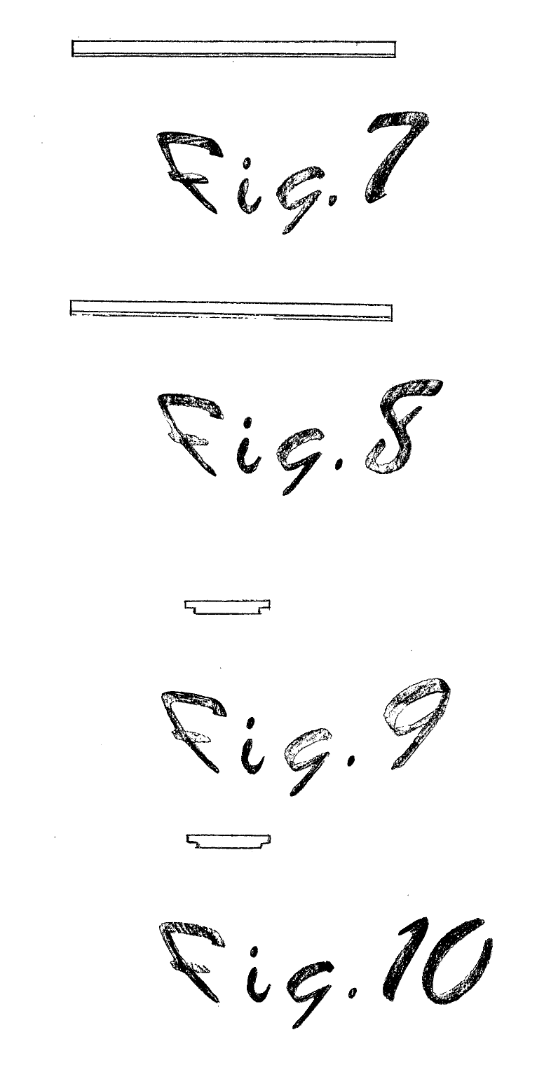

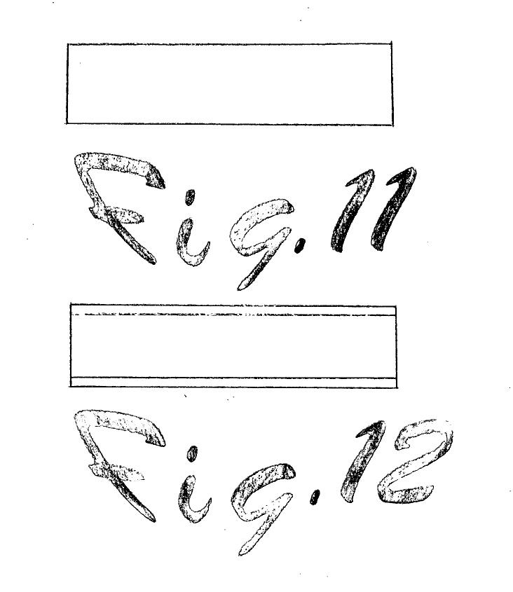

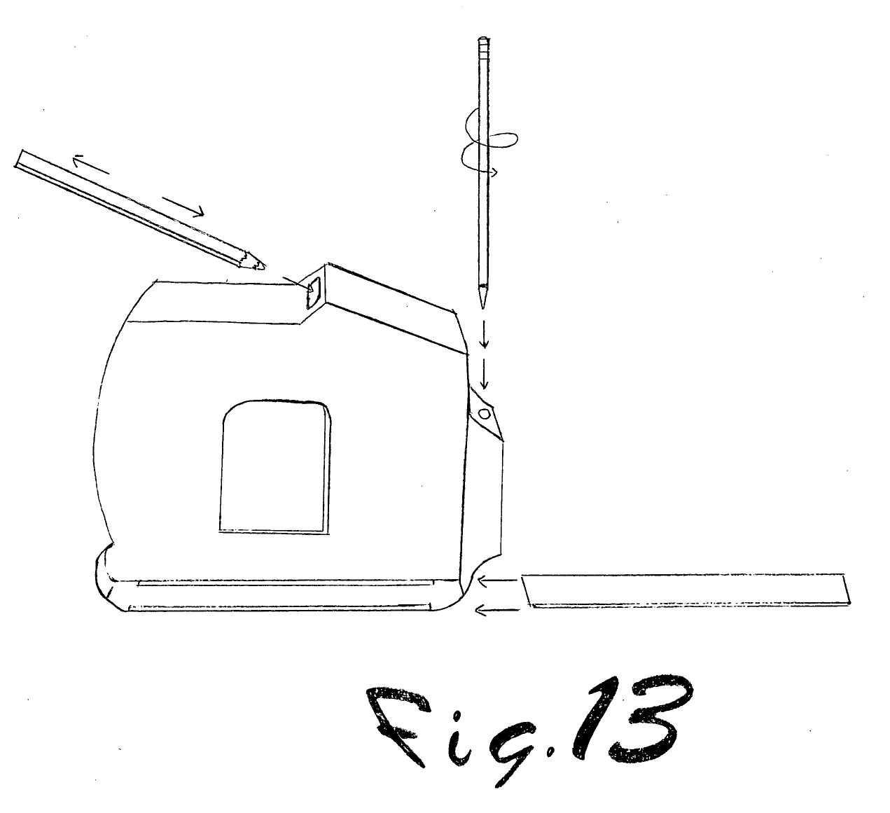

1. A multi-function plastic molded shell cover that is custom made to fit any 25 to 30 foot version tape measure that it's designed for.
Comprising on the mold are two separate pencil sharpeners.
Distinctively one sharpener sharpens the flat carpenters style pencil that's located on the top of the molded shell.
The other sharpener sharpens the standard number two pencil that's located on the right side of the molded shell.
Included on the front of the molded shell cover is a multi-point drill bit gauge.
Also on the front of the molded shell cover is a molded imprint of a one inch guide.
A separate component to the plastic molded shell cover is a flat machined magnet. The flat machined magnet extends the full length of the bottom opening After the tape measure is installed through the bottom opening, the magnet is manually installed from the right side of the plastic molded shell cover.
The magnet is slid under the tape measure on a small track that runs on both sides of the bottom opening of the molded shell. This track is an intact part of the molded shell and helps accomplish a secure fit for the tape measure.

2. A multi-function plastic molded cover according to claim 1, includes a pencil sharpener designed to sharpen the flat carpenter's style pencil. This sharpener is located on the top of the plastic molded cover and is an intact part of the mold.

3. A multi-function plastic molded cover according to claim 1, includes a pencil sharpener designed to sharpen the standard number two style pencil. This sharpener is located on the left side of the plastic molded cover and is an intact part of the mold.

4. A multi-function plastic molded cover according to claim 1, includes a multi-point drill bit gauge. This multi-point drill bit gauge is located offset to the right of the front face of the plastic molded cover and is an intact part of the mold.

5. A multi-function plastic molded shell cover according to claim 1, includes a molded imprinted one inch guide. This molded imprinted one inch guide is located offset to the left on the front face of the plastic molded cover and is an intact part of the mold.

6. A separate component to the plastic molded shell according to claim 1, is a flat machined magnet. This machined magnet extends to the full length of the bottom opening of the plastic molded shell. After the tape measure is installed through the bottom opening of the molded shell, the magnet is manually slid in from the right side and under the tape measure on a small track that runs on both sides of the bottom opening. This track is part of claim 1, and is an intact part of the molded shell as shown.
